(19) United States
(12) Patent Application Publication
(10) Pub. No.: US 2026/0334365 A1
(43) Pub. Date: Oct. 29, 2026

(54) FARMING COMBINE MAINTENANCE TOOL AND ASSOCIATED METHODS

(71) Applicants: Bradley Moss, Bozeman, MT (US); Brendan Leep, Manhattan, MT (US)

(72) Inventors: Bradley Moss, Bozeman, MT (US); Brendan Leep, Manhattan, MT (US)

(73) Assignee: Shop Dog Industries LLLP, Manhattan, MT (US)

(21) Appl. No.: 19/193,589

(22) Filed: Apr. 29, 2025

(51) Int. Cl. A01D 75/00; B08B 13/00

(52) U.S. Cl. CPC A01D 75/00; B08B 13/00

(57) ABSTRACT

The tool and method are for controlling the cleaning system of a self-propelled farming combine. The tool includes a wireless remote control system, a variable frequency drive (VFD) operating with a single-phase input to drive a three-phase motor, a motor connected to a gearbox which is coupled to a power transfer output (PTO) shaft linked to the combine's cleaning system. The VFD and remote control enable momentary PTO shaft operation, forward/reverse directions, preset speed options, and an automatic stop when remote signals cease, enhancing safety and efficiency. The method involves connecting the tool to the combine, using the remote to control operation and speed, and stopping the shaft without input, eliminating hydraulic drives for reduced surging, improved control, and simpler maintenance. The tool's compact design and adapters ensure compatibility with various combines, supporting inspections, repairs, and maintenance tasks.

### FIELD OF THE INVENTION

The present invention relates to farming combines, and more specifically to Fa tool and methods for running a combine during maintenance.

### BACKGROUND

Self-propelled farming combines are essential agricultural machines designed to harvest crops efficiently by integrating reaping, threshing, and cleaning processes into a single operation. The cleaning system, typically comprising sieves, fans, and conveyors, separates grain from chaff and debris, relying on mechanical motion driven by power transfer output (PTO) shafts or similar mechanisms.

Traditionally, these systems are operated using the combine's onboard hydraulic or mechanical drives, which are controlled directly from the cab or through manual adjustments during maintenance. However, such methods often lack precision and flexibility, particularly when servicing or repairing the cleaning system outside of active harvesting. Operators frequently need to access the cleaning system in a shop environment to remove blockages, perform inspections, or adjust components, requiring a reliable means to control the system independently of the combine's primary power source.

Conventional approaches to controlling combine cleaning systems during maintenance present several challenges. Hydraulic drive systems, commonly employed for PTO operation, can introduce surging, inconsistent speeds, and fluid leakage, complicating maintenance and reducing cleanliness in shop settings. Manual control methods or reliance on the combine's engine limit operational flexibility, often necessitating the machine's relocation or prolonged downtime. Additionally, safety concerns arise when operators must engage moving parts without precise, remote control options, increasing the risk of injury from unintended motion. Existing tools for auxiliary control, such as standalone PTO drivers, typically lack integration with modern electrical systems, offer limited speed variability, and fail to incorporate safety features like automatic shutdowns. As a result, there is a need for an improved tool that provides precise, safe, and efficient control of a combine's cleaning system, adaptable to various models and optimized for shop-based maintenance tasks.

This background information is provided to reveal information believed by the applicant to be of possible relevance to the present invention. No admission is necessarily intended, nor should be construed, that any of the preceding information constitutes prior art against the present invention.

### SUMMARY

The present application discloses embodiments that relate to a tool and method for controlling the cleaning system of a self-propelled farming combine, designed to enhance operational efficiency, safety, and maintenance simplicity in agricultural settings. The tool comprises a wireless remote control system, a variable frequency drive (VFD) configured to operate with a single-phase input and drive a three-phase motor, a three-phase motor connected to a gearbox, and a gearbox operatively coupled to a power transfer output (PTO) shaft that interfaces with the combine's cleaning system. The VFD and remote control system enable precise control of the PTO shaft, offering momentary operation through a pump function, forward and reverse directional capabilities, a plurality of preset speed options tailored to specific cleaning tasks, and an automatic stop feature that halts all operations in the absence of remote input signals, thereby enhancing user safety. Additional features include a housing with storage for adapters and drivelines to ensure compatibility with various combine models, and a compact design sized for placement in a shop adjacent to combine bays, facilitating consistent use without relocation.

The embodiments also encompass a method of operating the combine's cleaning system using the tool, involving connecting the tool to the PTO shaft, using the wireless remote control to send signals to the VFD for momentary control, selecting forward or reverse operation and desired speeds from preset options, and stopping the PTO shaft when input ceases. The method eliminates the need for hydraulic drives, reducing surging, improving control consistency, enhancing cleanliness, and simplifying maintenance. Safety features, such as requiring active engagement of a remote button for operation and stopping the tool if the remote is dropped, further improve its utility. By providing a portable, electrically driven solution with programmable settings and broad compatibility, this invention streamlines inspections, repairs, and maintenance of combine cleaning systems, offering a practical alternative to traditional hydraulic systems in modern farming operations.

The tool runs the cleaning system on a self-propelled combine for inspections, service, and repairs. The tool gives a technician control over the machine with wireless control allowing them to see all the moving components at very slow and controllable speeds. It also allows the technician to hear all the moving parts because there is no engine noise during this process. The technician can now move the combine components to exactly where he needs them when working on the combine. This eliminates a lot of physical labor for the technician and in many cases it makes a two person job a one person job.

### BRIEF DESCRIPTION OF THE DRAWINGS

The figures which accompany the written portion of this specification illustrate embodiments and method(s) of use according to the teachings of the present invention.

FIG. 1 is an schematic diagram illustrating a tool for controlling the cleaning system of a self-propelled farming combine according to an embodiment of the present invention.

FIG. 2 is a perspective view illustrating the tool of FIG. 1 positioned in a shop and coupled to a cleaning system of a combine, in accordance with the example embodiments.

FIG. 3 is a perspective view illustrating the tool of FIG. 1 with a PTO/driveline stored thereon, according to an embodiment of the present invention.

FIG. 4 is a top view illustrating the tool of FIG. 1 including the wireless remote control stored thereon, according to an embodiment of the present invention.

FIG. 5 is a side view illustrating the tool of FIG. 1 including storage areas for adapters and power cords, according to an embodiment of the present invention.

The figures are schematic, not necessarily to scale, and generally only shows parts which are necessary to elucidate example embodiments, wherein other parts can be omitted or merely suggested.

The various embodiments of the present invention will hereinafter be described in conjunction with the appended drawings, wherein like designations denote like elements.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

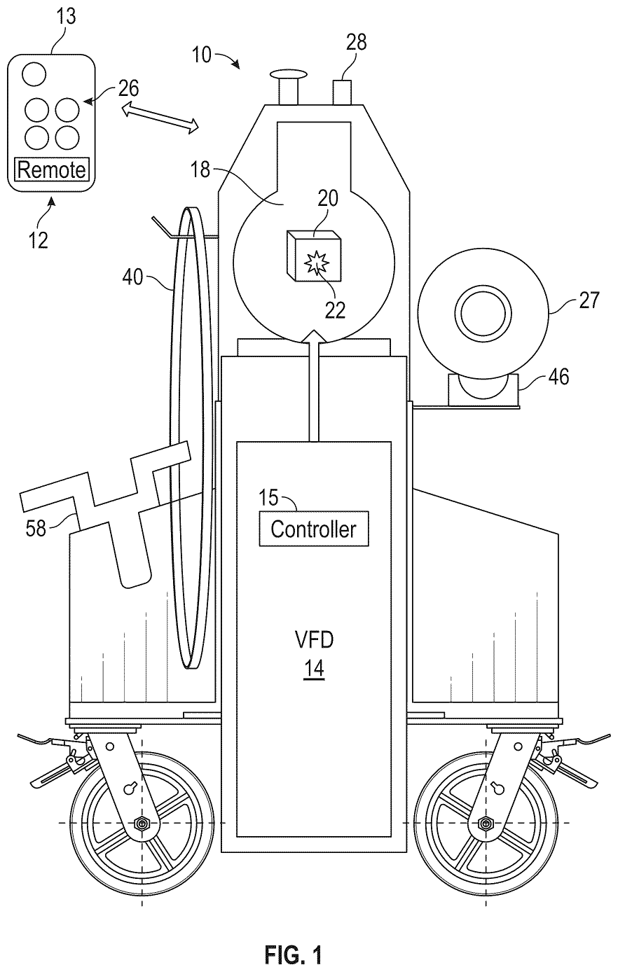

With The present invention pertains to a tool and method for controlling the cleaning system of a self-propelled farming combine, designed to improve operational precision, safety, and maintenance efficiency in agricultural environments. The following description refers to exemplary embodiments illustrated in FIGS. 1-5, which depict various aspects and configurations of the tool.

FIG. 1 is a schematic diagram illustrating a tool 10 for controlling the cleaning system of a self-propelled farming combine according to an embodiment of the present invention. The tool 10 comprises a wireless remote control system 12, a variable frequency drive (VFD) 14 configured to operate with a single-phase input and drive a three-phase motor 18 connected to a gearbox 20. The gearbox 20 is operatively connected to a power transfer output (PTO) shaft 22. The remote control system 12 may include a handheld wireless remote unit 13, and a controller 15 positioned at the VFD 14. The remote unit 13 is shown with buttons 26 (e.g. for various speed selections).

The PTO shaft 22 is configured to couple to the cleaning system of the combine, enabling controlled operation for tasks such as cleaning, servicing, or repairing. The VFD 14 and remote control system 12 are electrically linked to provide multiple functionalities: momentary control of the PTO shaft 22 via a pump function on the remote unit 13, operation of the PTO shaft 22 in forward or reverse directions through directional controls 28, selection of a plurality of preset speeds via programmed drive settings (e.g. via buttons 26), and an automatic stop mechanism that halts all PTO shaft 22 operations in the absence of input signals from the remote unit 13. This stop feature enhances safety by ensuring the tool 10 ceases operation if the remote unit 13 is dropped or not actively engaged. The VFD 14 eliminates the need for hydraulic drives, reducing surging, increasing control consistency, improving cleanliness, and simplifying maintenance of the tool 10.

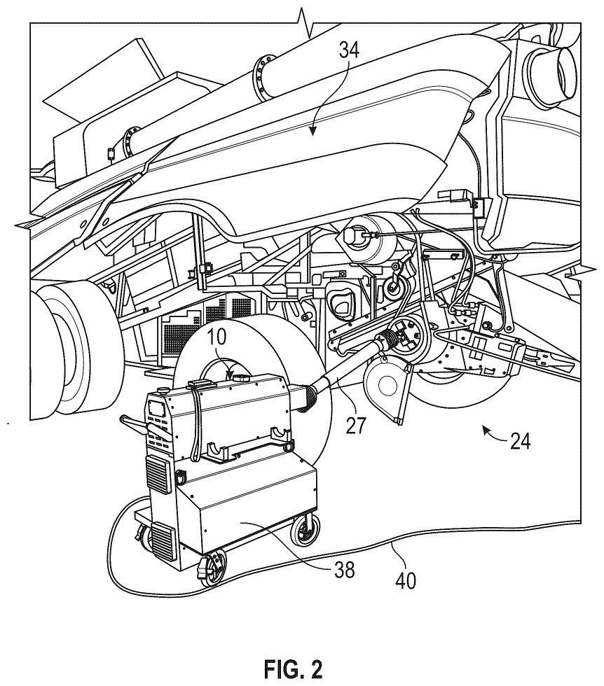

FIG. 2 is a perspective view illustrating the tool 10 of FIG. 1 positioned in a shop and coupled to a cleaning system 24 of a combine 34, in accordance with example embodiments. The tool 10 is shown placed adjacent to combine bays within a shop environment, its dimensions configured for efficient and consistent use without requiring relocation. The PTO shaft 22 extends from the gearbox 20 and connects to the cleaning system 24 via a driveline 27, which transmits rotational power to operate components such as sieves or fans within the combine 34. The enclosure/housing 38 shields the VFD 14 and motor 18 from dust and debris, maintaining operational integrity. The single-phase input is connected to a power cord 40 plugged into a shop outlet, highlighting the tool's adaptability to typical agricultural facilities. This configuration demonstrates the tool's practical application in performing inspections, repairs, or maintenance tasks with enhanced safety and precision.

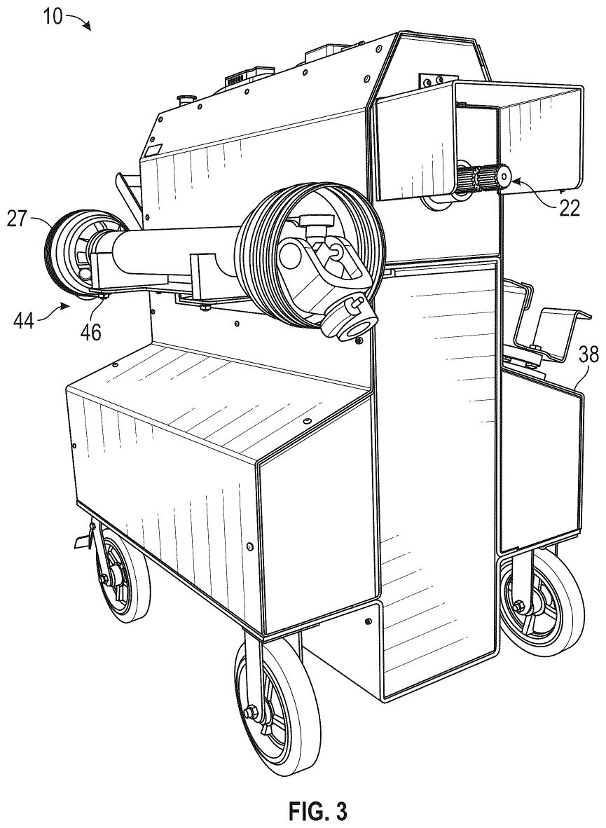

FIG. 3 is a perspective view illustrating the tool 10 of FIG. 1 with a driveline 27 stored thereon, according to an embodiment of the present invention. The tool 10 includes a storage area 44 specifically designed to hold the driveline 27 when not in use. The storage area 44 features brackets 46 that secure the driveline 27, preventing damage during transport or storage. The gearbox 20 is mounted within the enclosure/housing 38, with the three-phase motor 18 positioned adjacent to it, both accessible for maintenance. The VFD 14, enclosed within the enclosure/housing 38, is connected to the motor 18 via internal wiring, ensuring a compact and organized design. This view emphasizes the tool's portability and convenience, allowing operators to keep essential components together and readily available for deployment across different combine models.

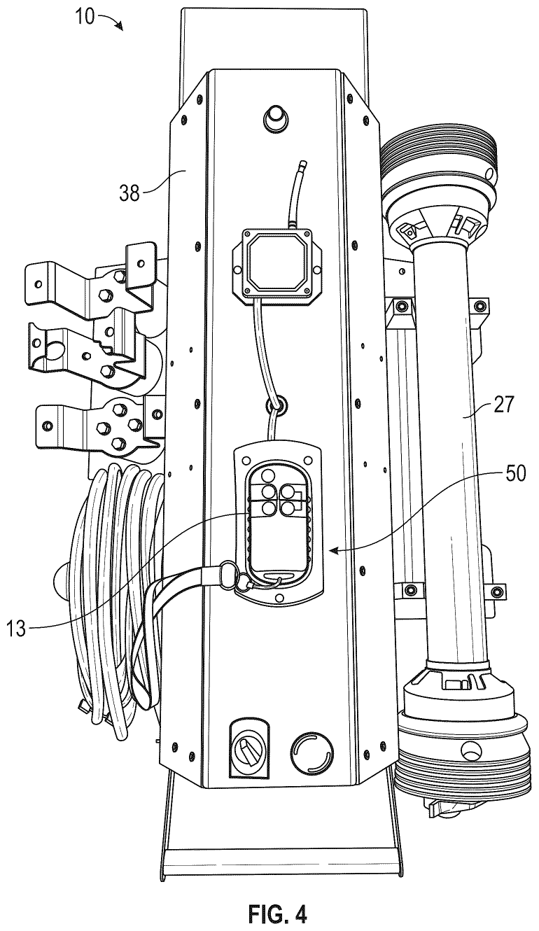

FIG. 4 is a top view illustrating the tool 10 of FIG. 1 including the wireless remote unit 13 stored thereon, according to an embodiment of the present invention. The housing 42 features a designated storage dock 50 for the remote unit 13 to secure it when not in use. The remote unit 13 includes the pump function (e.g. via button 26) for momentary control (requiring active engagement to operate the PTO shaft 22) and speed selection corresponding to the preset speed options programmed into the VFD 14. The top surface of the enclosure/housing 38 also protects the gearbox 20, with the PTO shaft 22 attachment point not visible, illustrating the tool's readiness for connection to a combine's cleaning system 24. This configuration highlights the tool's user-friendly design and safety features.

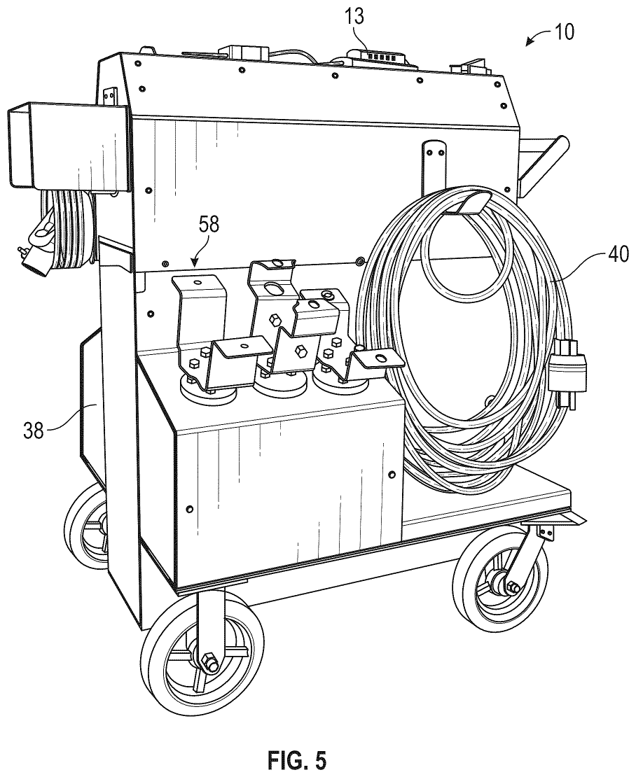

FIG. 5 is a side view illustrating the tool 10 of FIG. 1 including storage areas for adapters and power cords, according to an embodiment of the present invention. The enclosure/housing 38 incorporates additional storage areas designed to accommodate adapters 58 and a power cord 40. The adapters 58, which may include various PTO shaft connectors or driveline couplings, ensure compatibility with different types of farming combines, enhancing the tool's versatility. The power cord 40, shown coiled within the storage area, is connected to a single-phase input of the VFD 14, facilitating easy setup in a shop environment. The motor 18 and gearbox 20 are mounted within the enclosure/housing 38. The enclosure 38 protects the VFD 14, while the overall compact dimensions of the tool 10—optimized for shop placement-underscore its practicality for consistent use. This view illustrates the tool's self-contained design, supporting efficient storage and deployment for combine maintenance tasks.

In operation, the tool 10 is connected to the combine's cleaning system 24 via the PTO shaft 22 and driveline 27, and the wireless remote unit 13 is used to send signals to the VFD 14 for momentary control and speed selection. The method of use involves selecting preset speeds tailored to specific cleaning tasks, stopping operations when input ceases, and leveraging the tool's electrical drive system to eliminate hydraulic complexities, resulting in a cleaner, more maintainable solution. The embodiments depicted in FIGS. 1-5 collectively demonstrate a robust, adaptable tool that enhances the safety and efficiency of combine cleaning system operations.

The VFD is used to achieve short term, momentary control driven by the “pump function” on the remote control. This signal runs through a forward or reverse switch giving the drive a signal on which direction to operate the PTO. The second process to create momentary control through the drive and achieve different speeds is through the programming of the drive. The drive may be set to have preset speeds based off of inputs that are given to the drive through the remote control. Some speeds may be achieved by a combination of two inputs into the drive all though the drives programming. Because of the “pump function” on the remote, the drive may be getting at least two signals from the receiver to start the operation. It is important to note that all speeds are momentary, meaning that if a button is not being pushed on the remote control, the tool 10 will not operate. This gives the technician better control for stopping components in the exact place he needs, and most importantly it is a safety measure. If the technician sets down the remote or drops it, everything will come to a stop.

The tool is both a labor saving tool and a performance enhancing tool while addressing many safety issues. The tool may take the place of a second technician who would be required to be in the cab of the combine starting and stopping the threshing system while another guy watches or adjusts the moving components on the combine. In other instances, a technician will need a second person to turn over the machine by hand slowly so that he can place a certain component in a desired place. The tool gives the one technician complete control over the machine he is working on, giving him the ability to run at different speeds and most importantly, stop the machine exactly where he needs.

Similar to labor savings, when the technician has complete control over the combine at slow speeds, he is able to see and hear things much better than the alternative of not using the tool. For instance, a technician can lay eyes on a belt and move it very slowly so that he sees every inch of the belt. If you are not able to turn it over slowly, a guy would not see the entire belt to inspect all of it potentially missing a rip in it. The alternative here would be removing every belt on the machine to lay eyes on every inch of the belt, but this is a very labor intensive process (often doesn't end up happening). Another instance is changing out wearable parts. With the tool, a technician can “bump” the machine around extremely slowly while he removes certain wearable components and replaces them with new ones. This makes the process extremely efficient, and once again gives the technician the control he needs to start and stop the cleaning system in a safe way.

When considering the labor saving and performance, it is key that safety is not compromised but rather enhanced. The tool gives a technician slow and precise control so that they can safely be around moving parts. The tool has better/smoother control due to the new direct drive components. It also gives better momentary control so that everything comes to a stop if the technician is not intentionally making it turn. The tool also operates at a quieter sound level, which allows the technicians to communicate with each other.

Some of the illustrative aspects of the present invention may be advantageous in solving the problems herein described and other problems not discussed which are discoverable by a skilled artisan.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The foregoing disclosure provides illustration and description, but is not intended to be exhaustive or to limit the implementations to the precise form disclosed. Modifications and variations are possible in light of the above disclosure or may be acquired from practice of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As may be used herein, the terms “substantially” and “approximately” provides an industry-accepted tolerance for its corresponding term and/or relativity between items. Such an industry-accepted tolerance ranges from less than one percent to fifty percent. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module). As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While particular combinations of various functions and features of the present invention have been expressly described herein, other combinations of these features and functions are likewise possible. The present invention is not limited by the particular examples disclosed herein and expressly incorporates these other combinations.

The embodiments of the invention described herein are exemplary and numerous modifications, variations and rearrangements can be readily envisioned to achieve substantially equivalent results, all of which are intended to be embraced within the spirit and scope of the invention. Further, the purpose of any included abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The above description provides specific details, such as material types and processing conditions to provide a thorough description of example embodiments. However, a person of ordinary skill in the art would understand that the embodiments may be practiced without using these specific details.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A tool for controlling the cleaning system of a self-propelled farming combine, comprising:
a wireless remote control system;
a variable frequency drive (VFD) configured to operate with a single-phase input;
and drive a three-phase motor;
a three-phase motor driven by the VFD and connected to a gearbox;
the gearbox operatively connected to a power transfer output (PTO) shaft configured to be coupled to a cleaning system of the combine;
wherein the VFD and remote control system are configured to:
provide momentary control of the PTO shaft through a pump function on the remote control;
operate the PTO shaft in forward or reverse directions;
achieve a plurality of preset speeds through programmed drive settings; and
stop all operations of the PTO shaft in the absence of input signals from the remote control to enhance safety during use.

2. The tool of claim 1, wherein the wireless remote control system is configured to transmit at least two simultaneous signals to the variable frequency drive to initiate operation.

3. The tool of claim 1, wherein the momentary control functionality ensures that the PTO shaft operates only while a button on the remote control is actively engaged.

4. The tool of claim 1, further comprising a housing with storage areas for adapters and drivelines configured to connect the tool to various types of farming combines.

5. The tool of claim 1, wherein the variable frequency drive provides a plurality of preset speed options, each corresponding to specific operational requirements of the combine's cleaning system.

6. The tool of claim 1, wherein the VFD eliminates a need for hydraulic drives and provides:
reduced surging,
increased consistency in control,
improved cleanliness of the tool, and
simplified maintenance.

7. The tool of claim 1, wherein dimensions of the tool are configured for placement in a shop adjacent to combine bays, facilitating efficient and consistent use without relocation.

8. The tool of claim 1, wherein the remote control system includes a safety feature that stops all operations of the tool when the remote control is dropped or otherwise not actively engaged.

9. The tool of claim 1, wherein the variable frequency drive and remote control system are configured to operate in the momentary control, allowing intermittent starting and stopping of the PTO shaft.

10. A method of operating a cleaning system of a self-propelled farming combine, the method comprising:
coupling a tool comprising a wireless remote control system, a variable frequency drive (VFD), a three-phase motor, a gearbox, and a power transfer output (PTO) shaft to the cleaning system of the combine;
using the wireless remote control to send signals to the VFD for momentary control of the PTO shaft;
operating the PTO shaft in forward or reverse directions as selected for cleaning, servicing, and/or repairing the combine;
selecting a desired speed for the PTO shaft from a plurality of preset speed options;
stopping all operations of the PTO shaft when input signals from the remote control cease; and
performing inspections, repairs, or maintenance tasks on the combine's cleaning system with increased efficiency and safety.

11. The method of claim 10, further comprising programming the variable frequency drive to provide the preset speed options tailored for specific combine cleaning operations.

12. The method of claim 10, wherein the tool eliminates the use of hydraulic drives, resulting in a more compact and easier-to-maintain tool.

13. The method of claim 12, wherein the tool further provides:
reduced surging,
increased consistency in control,
improved cleanliness of the tool, and
simplified maintenance.

14. The method of claim 10, wherein the momentary control functionality ensures that the PTO shaft operates only while a button on the remote control is actively engaged.

15. The method of claim 10, further comprising providing adapters and drivelines configured to connect the tool, via the PTO shaft, to various types of farming combines.

16. The method of claim 10, wherein dimensions of the tool are configured for placement in a shop adjacent to combine bays, facilitating efficient and consistent use without relocation.

17. The method of claim 10, wherein the remote control system includes a safety feature that stops all operations of the tool when the remote control is dropped or otherwise not actively engaged.

18. The method of claim 10, wherein the variable frequency drive and remote control system are configured to operate in the momentary control, allowing intermittent starting and stopping of the PTO shaft.
